(19) United States
(12) Patent Application Publication
(10) Pub. No.: US 2026/0054899 A1
(43) Pub. Date: Feb. 26, 2026

(54) COMPOSTABLE HIGH BARRIER PACKAGING MATERIAL

(71) Applicant: MARS, INCORPORATED, McLean, VA (US)

(72) Inventors: David Sheldon, Campinas (BR); Eric Klingenberg, McLean, VA (US)

(73) Assignee: MARS, INCORPORATED, McLean, VA (US)

(21) Appl. No.: 19/308,143

(22) Filed: Aug. 22, 2025

Related U.S. Application Data
(60) Provisional application No. 63/686,129, filed on Aug. 22, 2024.

(51) Int. Cl. B65D 65/46; B32B 7/12; B32B 27/10; B32B 27/36; B65D 65/40

(52) U.S. Cl. CPC B65D 65/466; B32B 7/12; B32B 27/10; B32B 27/36; B65D 65/40; B32B 2307/7163; B32B 2307/718; B32B 2307/7244; B32B 2439/70; B65D 2565/387

(57) ABSTRACT

A compostable packaging material having a high barrier to water and oxygen is provided. Such compositions can have a film layer comprising polyhydroxyalkanoate (PHA), a bonding layer, and a substrate layer. The compostable packaging material can be compostable at home or industrially as well as anaerobically digested.

### 1. CROSS-REFERENCE TO RELATED APPLICATION

This application claims priority to U.S. Provisional Application Ser. No. 63/686,129, filed on Aug. 22, 2024, which is incorporated herein by reference in its entirety.

### 2. FIELD

The presently disclosed subject matter relates to a compostable and recyclable packaging material containing polyhydroxyalkanoate.

### 3. BACKGROUND

There is increasing concern that modern-day packaging and materials, such as single-use packaging, are not readily compostable and recyclable, but rather take up space in landfills. For example, the World Wildlife Fund reports that a single use takeout coffee cup having a plastic lining will decompose in approximately 30 years in a landfill, as reported in “The Lifecycle of Plastics” (available at wwf.org.au/blogs/the-lifecycle-of-plastics/, last accessed Apr. 22, 2024). As plastics and other packaging materials become more prevalent in society, the resulting environmental impact has led to a need for better compostable packaging.

When designing packaging such as for food products, engineers consider various features to develop quality, efficient, cost-effective, and environmentally friendly packaging. Examples of these features include the value of oxygen transmission rates, moisture vapor transmission rate and the tensile strength of the packaging. The oxygen transmission rate and moisture vapor transmission rates, measures of gas transport, is the rate of transport through the package of gases known to effect product stability and quality. The tensile strength of a package is the maximum stress that can be applied to the packaging before it breaks. Various techniques can be used to improve these properties.

To aid with compostability and recyclability, biodegradable polymers have been considered as an alternative to traditional petroleum-based polymers for packaging in recent years. Polyhydroxyalkanoates (PHAs) and poly(lactic acid) (PLA) are both biodegradable polyesters applied as polymers to packaging for use in food packaging. Poly(lactic acids) (PLA) is produced from corn, a renewable resource. However, polymers such as PLA, can demonstrate poor characteristics such as with respect to impact resistance, toughness, and thermal resistance. Polyhydroxyalkanoate (PHA) is generated from bacteria, which makes the PHAs easily biodegradable when exposed to the bacteria found in soils. (Naser, A. Z., et al. Polymers. 13:4271). In addition to the case at which PHA can be composted, the polymers also provide improved gas barrier properties for moisture and oxygen as compared to PLA. However, PHA alone can have issues with respect to durability and strength characteristics and can have a low-quality texture when used in the packaging industry.

Food packaging materials that are currently used have various other undesirable features, such as a poor gas barrier. Thus, there remains a need in the art for improved, compostable and recyclable packaging material that can be used in various industries, such as the food packaging industry, which meets the quality, durability, texture and feel of traditional plastics material and packaging, along with other desired features, such as an optimal oxygen barrier and tensile strength. The use of a biodegradable polymer with a multi-layer structure, having a biodegradable polymer-based barrier film, would provide for a unique package that meets the high-performance demands of certain foods.

### 4. SUMMARY

The purpose and advantages of the disclosed subject matter will be set forth in and are apparent from the description that follows, as well as will be learned by practice of the disclosed subject matter. Additional advantages of the disclosed subject matter will be realized and attained by the devices particularly pointed out in the written description and claims hereof, as well as from the appended drawings.

To achieve these and other advantages and in accordance with the purpose of the disclosed subject matter, as embodied and broadly described, the disclosed subject matter includes a compostable packaging material comprising a film layer comprising polyhydroxyalkanoate (PHA), a bonding layer, and a substrate layer, wherein the compostable packaging material has a water vapor transmission rate of from about 0.05 gm/m²/day to about 7.5 gm/m²/day at 38° C. and 90% Relative Humidity and from about 0.001 gm/m²/day to about 2.0 gm/m²/day at 25° C. and 50% Relative Humidity, wherein the compostable packaging material is configured to be assembled into a package to contain a food product or pet product and is configured to be compostable.

In certain embodiments, the compostable packaging material has an oxygen transmission rate of from about 0.1 cc/m²/day to about 15 cc/m²/day at 25° C. at 0% Relative Humidity, and of from about 0.1 cc/m²/day to about 30 cc/m²/day at 25° C. at 50% Relative Humidity.

In particular embodiments, the film layer of PHA comprises a PHA sublayer, a primer sublayer, and a coating barrier sublayer. In certain embodiments, the coating barrier sublayer comprises aluminum, aluminum oxide, silicon oxide, graphene, chitin and/or chitosan, chitin and/or chitosan mixed with inorganic clays, or montmorillonite blends.

In particular embodiments, the film layer has a thickness of less than about 50 μm. In certain embodiments, the substrate layer comprises cellulose acetate, PHA, paper, a pulp, or a board material. In particular embodiments, the substrate layer is PHA having a thickness of from about 5 μm to about 90 μm. In certain embodiments, the substrate layer is paper having a basis weight of from about 18 gsm to about 600 gsm. In particular embodiments, the substrate layer is a board or pulp having a basis weight of from about 10 gsm to about 1000 gsm. In certain embodiments, the bonding layer is an adhesive layer. In particular embodiments, the adhesive layer has a basis weight of from about 0.1 gsm to about 10 gsm.

In accordance with another aspect of the disclosed subject matter, the present disclosure provides a compostable package, comprising a housing configured to contain food therein, the housing including a compostable packaging material comprising a film layer comprising polyhydroxyalkanoate, a bonding layer, and a substrate layer, wherein the compostable packaging material has a water vapor transmission rate of from about 0.05 gm/m²/day to about 7.5 gm/m²/day at 38° C. and 90% Relative Humidity, and from about 0.001 gm/m²/day to about 2.0 gm/m²/day at 25° C. and 50% Relative Humidity.

In particular embodiments the compostable packaging material has an oxygen transmission rate of from about 0.1 cc/m²/day to about 15 cc/m²/day at 25° C. at 0% Relative Humidity, and of from about 0.1 cc/m²/day to about 30 cc/m²/day at 25° C. at 50% Relative Humidity.

In certain embodiments, the film layer comprises a PHA sublayer, a primer sublayer, and a barrier sublayer. In certain embodiments, the substrate layer comprises cellulose acetate, PHA, paper, a pulp, or a board material. In certain embodiments, the bonding layer is an adhesive layer with a basis weight of from about 0.1 gsm to about 10 gsm.

In particular embodiments, the compostable package further comprises a food product or a pet product therein.

In accordance with another aspect of the disclosed subject matter, the present disclosure provides a method of making a compostable package material, comprising coating polyhydroxyalkanoate (PHA) with a primer sublayer and a barrier sublayer to form a film layer, processing the coated film with a bonding layer to create an intermediate product, and coupling the intermediate product with a substrate layer to create a compostable packaging material, wherein the substrate layer includes at least one of cellulose acetate, PHA, paper, a pulp, or a board, wherein the compostable packaging material has a water vapor transmission rate of from about 0.05 gm/m²/day to about 7.5 gm/m²/day at 38° C. and 90% Relative Humidity and from about 0.001 gm/m²/day to about 2.0 gm/m²/day at 25° C. and 50% Relative Humidity.

In certain embodiments, the method of making a compostable package further comprises forming the compostable packaging material into a package.

In particular embodiments, the method further comprises forming the compostable packaging material into a package. In certain embodiments, the compostable packaging material has an oxygen transmission rate of from about 0.1 cc/m²/day to about 15 cc/m²/day at 25° C. at 0% Relative Humidity, and of from about 0.1 cc/m²/day to about 30 cc/m²/day at 25° C. at 50% Relative Humidity.

It is to be understood that both the foregoing general description and the following detailed description and drawings are examples and are provided for purpose of illustration and not intended to limit the scope of the disclosed subject matter in any manner.

The accompanying drawings, which are incorporated in and constitute part of this specification, are included to illustrate and provide a further understanding of the devices of the disclosed subject matter. Together with the description, the drawings serve to explain the principles of the disclosed subject matter.

### 5. BRIEF DESCRIPTION OF THE DRAWINGS

The subject matter of the application will be more readily understood from the following detailed description when read in conjunction with the accompanying drawings, in which:

FIG. 1 provides a cross-sectional view of the compostable packaging material layers;

FIG. 2 provides a flow chart of a manufacturing method to create the compostable packaging material;

FIG. 3 shows a package having compostable packaging material according to the disclosed subject matter; and

FIG. 4 shows a blank having compostable packaging material according to the disclosed subject matter.

### 6. DETAILED DESCRIPTION

Compostable packaging material, packaging, and methods of making the same are provided. Such compositions advantageously have a high barrier, are recyclable, and are compostable. These and other aspects of the disclosed subject matter are discussed in more detail below.

For clarity and not by way of limitation, this detailed description is divided into the following sub-portions:
6.1 Definitions;
6.2 Compostable Packaging Materials;
6.3 Compostable Packaging Material Properties; and
6.4 Packaging and Consumer Products.

### 6.1. Definitions

The terms used in this specification generally have their ordinary meanings in the art, within the context of this subject matter, and in the specific context where each term is used. Certain terms are defined below to provide additional guidance in describing the compositions and methods of the disclosed subject matter and how to make and use them.

As used in the specification and the appended claims, the singular forms “a,” “an,” and “the” include plural referents unless the context clearly dictates otherwise. Thus, for example, reference to “a compound” includes mixtures of compounds.

The term “about” or “approximately” means within an acceptable error range for the particular value as determined by one of ordinary skill in the art, which will depend in part on how the value is measured or determined, i.e., the limitations of the measurement system. For example, “about” can mean within three or more than three standard deviations, per the practice in the art. Alternatively, “about” can mean a range of up to 20%, preferably up to 10%, more preferably up to 5%, and more preferably still up to 1% of a given value. Also, particularly with respect to systems or processes, the term can mean within an order of magnitude, preferably within five-fold, and more preferably within two-fold, of a value.

As used herein, the terms “comprises,” “comprising,” or any other variation thereof, are intended to cover a non-exclusive inclusion, such that a process, method, article, or apparatus that comprises a list of elements does not include only those elements but can include other elements not expressly listed or inherent to such process, method, article, or apparatus.

In the detailed description herein, references to “embodiment,” “an embodiment,” “one embodiment,” “in various embodiments,” etc., indicate that the embodiment(s) described can include a particular feature, structure, or characteristic, but every embodiment might not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

The terms “biodegradable packaging” and “compostable packaging” refer to packaging compositions that are biodegradable, or compostable. Such packaging can be biodegradable or compostable at home or industrially and/or anaerobically digestible.

The terms “barrier”, “gas barrier property”, “barrier property”, or “barrier performance” relate to the barrier provided by the compostable packing material in limiting oxygen and/or water to transmit therethrough over a period of time and is measured by way of an oxygen transmission rate and a water vapor transmission rate, respectively.

As used herein, the term “food product” refers to food products for human consumption or non-human consumption. Non-human food products can include animal food products, and more specifically, to pet food products. Pet food products described herein can be any pet food product known in the art. Such pet food products can include, but are not limited to daily feed, kibble, treats, and/or supplements.

As used herein, the term “pet product” relates to products for pets including but not limited to chew toys for pets or other non-edible pet products.

### 6.2. Compostable Packaging Materials

The presently disclosed subject matter provides for recyclable and compostable packaging material that has a high barrier to oxygen and water vapor transmission. The compostable packaging material can include (i) a film layer comprising polyhydroxyalkanoate (PHA), (ii) a bonding layer, and (iii) a substrate layer. Each of these layers is discussed in further detail below.

### 6.2.1. Film Layer

The compostable packaging material comprises a film layer, which is an interior layer of the overall packaging material. The film layer can comprise a single sublayer of PHA. Alternatively, the film layer can comprise three sublayers, including a PHA sublayer, a primer sublayer, and a barrier sublayer.

Polyhydroxyalkanoate (PHA) is a biodegradable polymer which can be produced using a variety of fungi, bacteria and archaebacteria. PHA, which is a linear polyester, has the following structure:

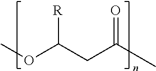

where R is a linear or branched alkyl group. When R is three to five carbons in length the PHA is a short chain length PHA, when R is six to fourteen carbons in length the PHA is a medium chain length PHA, and when R is greater than fourteen carbons in length the PHA is a long chain length PHA. The chain length can influence properties such as tensile strength and glass transition temperature. (Sehgal, R. et al. 3 Biotech. 10(12):549.). Often, PHA co-polymers are used, where a mixture of various side chain lengths is in the same polymer backbone. These biodegradable polymers are readily compostable in the presence of bacteria, providing non-toxic products such as water and biomass. (Acharjee, S. A., et al. Water Air Soil Pollut. 234(1):21.). Thus, PHA can be applied as a resin layer for use in the film layer. In the present application, the PHA layer can comprise PHA alone, or a blend of PHA and one or more other compostable polymers, including but not limited to poly(lactic acid) (PLA), poly(butylene succinate) (PBS), poly(butylene adipate-co-terephthalate) (PBAT), and poly(glycolic acid) (PGA). In certain embodiments, the amount of PHA is at least about 50% of the total amount of the PHA layer. In certain embodiments, the PHA layer can be used alone or in combination with a primer sublayer and a barrier sublayer.

The primer sublayer, when present, acts as a smoothing layer between the PHA sublayer and barrier sublayer. Such primer materials are known in the art, including, but not limited to, poly(vinyl alcohol) (PVOH), ethylene vinyl alcohol (EVOH), polyamides, polyurethanes, and acrylic polymers.

Any suitable barrier can be used as the barrier sublayer. For example, the barrier can be aluminum, aluminum oxide (AlOx or Al₂O₃), silicon oxide (SiOx or SiO₂), graphene, chitin and/or chitosan, chitin and/or chitosan mixed with inorganic clays, or montmorillonite blends. In particular embodiments, the barrier is aluminum. When the barrier sublayer is aluminum, the film layer is “metalized PHA”. When the barrier sublayer is aluminum oxide, the film layer is “AlOx PHA”. When the barrier sublayer is silicon oxide, the film layer is “SiOx PHA”.

The barrier sublayer can be adhered to the primer sublayer and PHA sublayer by any suitable means to form the film layer. In certain embodiments, the barrier sublayer is adhered to the primer sublayer by vacuum metallization.

In a particular embodiment, the film layer can comprise PHA. When used alone, the PHA layer can have a thickness of from about 6 μm to about 60 μm, from about 8 μm to about 40 μm, or from about 10 μm to about 30 μm.

In an alternative embodiment, the film layer can comprise a PHA sublayer, a primer sublayer, and a barrier sublayer. In these embodiments, the PHA sublayer can have a thickness of from about 6 μm to about 60 μm, from about 8 μm to about 40 μm, or from about 10 μm to about 30 μm. The primer sublayer can have a thickness of from about 0.00001 μm to about 12 μm, from about 0.00001 μm to about 7 μm, from about 0.00001 μm to about 5 μm, from about 0.00001 μm to about 2 μm, or from about 0.1 μm to about 2 μm. The barrier sublayer can have a thickness of greater than about 0.5 nm, from about 0.5 nm to about 10 nm, from about 1 nm to about 7 nm, or from about 3 nm to about 5 nm.

When the film layer comprises a PHA sublayer, a primer sublayer, and a barrier sublayer, the overall film layer has a thickness of from about 0.01 nm to about 20 μm, from about 0.1 nm to about 15 μm, from about 0.5 nm to about 10 μm, or from about 1 nm to about 5 μm. In alternative embodiments, when the film layer comprises a PHA sublayer, a primer sublayer, and a barrier sublayer, the overall film layer has a thickness of less than about 50 μm, less than about 40 μm, less than about 20 μm, or less than about 10 μm.

### 6.2.2. Bonding Layer

In addition to the film layer, the compostable packaging material can also include a bonding layer. The bonding layer can serve to adhere or bond together the film layer to the substrate layer. In certain embodiments, the bonding layer can include an adhesive material. In an alternative embodiment, the bonding layer can include a material that can be heated to assist with thermal bonding of the layers. Alternatively, the bonding layer can be a wet layer comprising a solvent. Alternatively, the bonding layer can be a water-based solvent.

In alternative embodiments, a bonding layer does not need to be present, where the layers of the compostable packaging material can bound by alternative heat (dry), wet (solvent free, solvent, or water based), or extrusion conditions.

When the bonding layer is an adhesive layer, any suitable adhesive that is water-based, solvent-based, or solvent-less can be used. A water-based adhesive can include Epotal® P100 ECO (BASF), ST6093 (SciTech), or 993-1148 (Sun Chemical), a solvent-based adhesive can include PS255 ECO (Morchem), Adcole BL1001 (Dow), or BE-A 910 (Henkel), and a solvent-less, or dry, adhesive can include LA8195/LA7394 (Henkel) or SFC 100/HAC306 (Sun Chemical). In certain embodiments, the adhesive is a laminating adhesive.

When an adhesive layer is provided, the adhesive layer can be applied between the film layer and the substrate layer to provide a suitable coating for the substrate to be bonded to the film layer. An adhesive layer comprises an adhesive in a basis weight of from about 0.1 gsm to about 10 gsm, from about 0.1 gsm to about 5 gsm, from about 0.2 gsm to about 10 gsm, or from about 0.3 gsm to about 5 gsm.

### 6.2.3. Substrate Layer

In addition to a film layer and a bonding layer, the compostable packaging material can also include a substrate layer. The substrate layer is bonded to the film layer, either with the use of an intermediate bonding layer, or the substrate layer can be directly bonded to the film layer.

Any suitable substrate can be used as the substrate layer. In certain embodiments, the substrate is cellulose acetate, PHA, paper, pulp, or a board material. A pulp or board material can include, but is not limited to, chemi-thermo mechanical pulp, solid bleached sulfate board, folding box board, thermo-mechanical pulp, or solid unbleached sulfate board.

In particular embodiments, when the substrate is PHA, the substrate layer can have a thickness of at least about 1 μm, at least about 5 μm, at least about 8 μm, or at least about 12 μm. In alternative embodiments, when the substrate is PHA, the substrate layer can have a thickness of from about 5 μm to about 90 μm, from about 10 μm to about 80 μm, from about 12 μm to about 70 μm, or from about 12 μm to about 40 μm.

In particular embodiments, when the substrate is paper, the substrate layer can have a basis weight of at least about 18 gsm, at least about 20 gsm, or at least about 25 gsm. In alternative embodiments, when the substrate is paper, the substrate layer can have a basis weight of from about 18 gsm to about 600 gsm, from about 20 gsm to about 550 gsm, from about 25 gsm to about 100 gsm, from about 25 gsm to about 250 gsm, from about 250 gsm to about 500 gsm, or from about 25 gsm to about 500 gsm.

In particular embodiments, when the substrate is a board or pulp, the substrate layer can have a basis weight of from about 10 gsm to about 1000 gsm, from about 50 gsm to about 750 gsm, or from about 100 gsm to about 500 gsm.

### 6.2.4. Additional Components

The compostable packaging material can further include additional components. Any suitable additional component can be used. For example, additional components can include but are not limited to compostable ink, over print varnish, anti-scuff coatings, cold seal adhesives, cold seal release coatings, or pressure sensitive adhesives.

### 6.2.5. Compostable Packaging Compositions

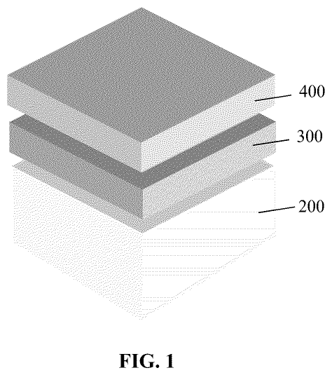

The compostable packaging material of the present disclosure can at least include a film layer, a bonding layer, and a substrate layer. FIG. 1 illustrates a cross-section of the compostable packaging material according to an embodiment of the disclosed subject matter. The compostable packaging material 100 contains a film layer 200, a bonding layer 300, and a substrate layer 400 as shown in FIG. 1.

In particular embodiments, the compostable packaging material can comprise non-compostable material. The non-compostable material can be one material or a mixture of suitable non-compostable materials. Each individual non-compostable material is present in an amount of greater than about 1 wt. % of the compostable packaging material. The total non-compostable materials present in the compostable packaging material is less than about 5 wt. %.

In certain embodiments, the compostable packaging material comprises a film layer of metalized PHA, a bonding layer of water-based adhesive, and a substrate layer of paper. In certain embodiments, the compostable packaging material comprises a film layer of metalized PHA, a bonding layer of a water-based adhesive, and a substrate layer of PHA. In certain embodiments, the compostable packaging material comprises a film layer of metalized PHA, a bonding layer of a water-based adhesive, and a substrate layer of a board or pulp. In certain embodiments, the compostable packaging material comprises a film layer of metalized PHA, a bonding layer of a water-based adhesive, and a substrate layer of cellulose acetate.

In certain embodiments, the compostable packaging material comprises a film layer of metalized PHA, a bonding layer of a solvent-based adhesive, and a substrate layer of paper. In certain embodiments, the compostable packaging material comprises a film layer of metalized PHA, a bonding layer of a solvent-based adhesive, and a substrate layer of PHA. In certain embodiments, the compostable packaging material comprises a film layer of metalized PHA, a bonding layer of a solvent-based adhesive, and a substrate layer of a board or pulp. In certain embodiments, the compostable packaging material comprises a film layer of metalized PHA, a bonding layer of a solvent-based adhesive, and a substrate layer of cellulose acetate.

In certain embodiments, the compostable packaging material comprises a film layer of metalized PHA, a bonding layer of a solvent-free adhesive, and a substrate layer of paper. In certain embodiments, the compostable packaging material comprises a film layer of metalized PHA, a bonding layer of a solvent-free adhesive, and a substrate layer of PHA. In certain embodiments, the compostable packaging material comprises a film layer of metalized PHA, a bonding layer of a solvent-free adhesive, and a substrate layer of a board or pulp. In certain embodiments, the compostable packaging material comprises a film layer of metalized PHA, a bonding layer of a solvent-free adhesive, and a substrate layer of cellulose acetate.

In certain embodiments, the compostable packaging material comprises a film layer of AlOx PHA, a bonding layer of a water-based adhesive, and a substrate layer of paper. In certain embodiments, the compostable packaging material comprises a film layer of AlOx PHA, a bonding layer of a water-based adhesive, and a substrate layer of PHA. In certain embodiments, the compostable packaging material comprises a film layer of AlOx PHA, a bonding layer of a water-based adhesive, and a substrate layer of a board or pulp. In certain embodiments, the compostable packaging material comprises a film layer of AlOx PHA, a bonding layer of a water-based adhesive, and a substrate layer of cellulose acetate.

In certain embodiments, the compostable packaging material comprises a film layer of AlOx PHA, a bonding layer of a solvent-based adhesive, and a substrate layer of paper. In certain embodiments, the compostable packaging material comprises a film layer of AlOx PHA, a bonding layer of a solvent-based adhesive, and a substrate layer of PHA. In certain embodiments, the compostable packaging material comprises a film layer of AlOx PHA, a bonding layer of a solvent-based adhesive, and a substrate layer of a board or pulp. In certain embodiments, the compostable packaging material comprises a film layer of AlOx PHA, a bonding layer of a solvent-based adhesive, and a substrate layer of cellulose acetate.

In certain embodiments, the compostable packaging material comprises a film layer of AlOx PHA, a bonding layer of a solvent-free adhesive, and a substrate layer of paper. In certain embodiments, the compostable packaging material comprises a film layer of AlOx PHA, a bonding layer of a solvent-free adhesive, and a substrate layer of PHA. In certain embodiments, the compostable packaging material comprises a film layer of AlOx PHA, a bonding layer of a solvent-free adhesive, and a substrate layer of a board or pulp. In certain embodiments, the compostable packaging material comprises a film layer of AlOx PHA, a bonding layer of a solvent-free adhesive, and a substrate layer of cellulose acetate.

In certain embodiments, the compostable packaging material comprises a film layer of SiOx PHA, a bonding layer of a water-based adhesive, and a substrate layer of paper. In certain embodiments, the compostable packaging material comprises a film layer of SiOx PHA, a bonding layer of a water-based adhesive, and a substrate layer of PHA. In certain embodiments, the compostable packaging material comprises a film layer of SiOx PHA, a bonding layer of a water-based adhesive, and a substrate layer of a board or pulp. In certain embodiments, the compostable packaging material comprises a film layer of SiOx PHA, a bonding layer of a water-based adhesive, and a substrate layer of cellulose acetate.

In certain embodiments, the compostable packaging material comprises a film layer of SiOx PHA, a bonding layer of a solvent-based adhesive, and a substrate layer of paper. In certain embodiments, the compostable packaging material comprises a film layer of SiOx PHA, a bonding layer of a solvent-based adhesive, and a substrate layer of PHA. In certain embodiments, the compostable packaging material comprises a film layer of SiOx PHA, a bonding layer of a solvent-based adhesive, and a substrate layer of a board or pulp. In certain embodiments, the compostable packaging material comprises a film layer of SiOx PHA, a bonding layer of a solvent-based adhesive, and a substrate layer of cellulose acetate.

In certain embodiments, the compostable packaging material comprises a film layer of SiOx PHA, a bonding layer of a solvent-free adhesive, and a substrate layer of paper. In certain embodiments, the compostable packaging material comprises a film layer of SiOx PHA, a bonding layer of a solvent-free adhesive, and a substrate layer of PHA. In certain embodiments, the compostable packaging material comprises a film layer of SiOx PHA, a bonding layer of a solvent-free adhesive, and a substrate layer of a board or pulp. In certain embodiments, the compostable packaging material comprises a film layer of SiOx PHA, a bonding layer of a solvent-free adhesive, and a substrate layer of cellulose acetate.

The compostable packaging material of the present disclosure can be manufactured using any suitable manufacturing method. Advantageously, the compostable packaging material can be manufactured using existing methods of manufacturing packaging. In certain embodiments, the compostable packaging material composition can be blown into a desired compostable packaging. In particular embodiments, the compostable packaging material composition can be extruded into a desired compostable packaging.

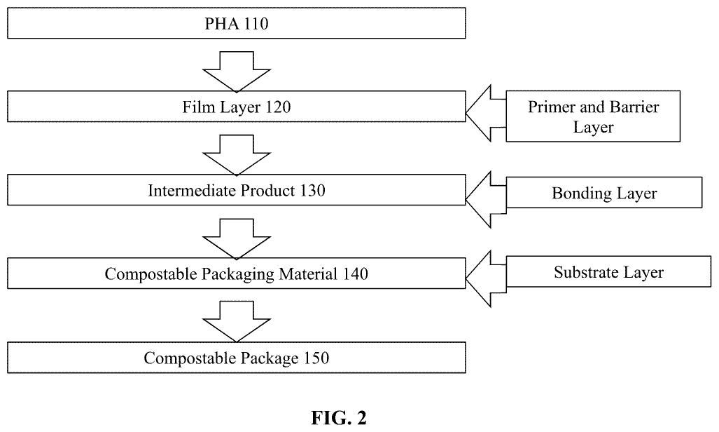

The compostable packaging material can be manufactured in different steps to create the monolithic material. As provided in FIG. 2 in certain embodiments, the compostable package is manufactured by coating polyhydroxyalkanoate (PHA) 110 with a primer sublayer and a barrier sublayer to create a film layer 120, processing the film layer with bonding layer to create an intermediate product 130, and coupling the intermediate product with a substrate layer to create a compostable packaging material 140. The material can then be formed into a compostable package 150 with any desired specifications.

### 6.3. Compostable Packaging Material Properties

The compostable packaging material of the present disclosure will have specific mechanical and thermal properties. These properties include an oxygen transmission rate, water vapor transfer rate, coefficient of friction, lamination bond strength, and tensile strength all within predetermined acceptable ranges.

### 6.3.1. Oxygen Transmission Rate

As used herein, the oxygen transmission rate relates to a measurement of the amount of oxygen gas that passes through the compostable packaging material at a controlled temperature and humidity. The oxygen transmission rate of the present disclosure is measured at 25° C. and 0% Relative Humidity (RH) and at 25° C. and 50% RH based on the ASTM D-3985 method.

In certain embodiments, the, the compostable packaging material of the present disclosure has an oxygen transmission rate at 25° C. and 0% RH of from about 0.10 cc/m²/day to about 15 cc/m²/day, from about 0.20 cc/m²/day to about 12 cc/m²/day, or from about 0.30 cc/m²/day to about 10 cc/m²/day.

In alternative embodiments, the, the compostable packaging material of the present disclosure has an oxygen transmission rate at 25° C. and 50% RH of from about 0.10 cc/m²/day to about 30 cc/m²/day, from about 0.20 cc/m²/day to about 10 cc/m²/day, or from about 0.25 cc/m²/day to about 8 cc/m²/day.

### 6.3.2. Water Vapor Transmission Rate

As used herein, the water transmission rate relates to a measurement of the amount of water vapor that passes through the compostable packaging material at a controlled temperature and humidity. Water vapor transmission rate of the present disclosure is measured at 38° C. and 90% RH, 25° C. and 50% RH, and 35° C. and 85% RH using the ASTM F-1249 method.

In certain embodiments, the compostable packaging material of the present disclosure has an water vapor transmission rate at 38° C. and 90% RH of from about 0.05 gm/m²/day to about 7.5 gm/m²/day, from about 0.1 gm/m²/day to about 5.0 gm/m²/day, or from about 0.15 gm/m²/day to about 3.0 gm/m²/day.

In alternative embodiments, the compostable packaging material of the present disclosure has a water vapor transmission rate at 25° C. and 50% RH of from about 0.001 gm/m²/day to about 2.0 gm/m²/day, from about 0.005 gm/m²/day to about 1.0 gm/m²/day, or from about 0.01 gm/m²/day to about 0.5 gm/m²/day.

In alternative embodiments, the compostable packaging material of the present disclosure has a water vapor transmission rate at 35° C. and 85% RH of from about 0.01 gm/m²/day to about 1.5 gm/m²/day, or from about 0.05 gm/m²/day to about 1.2 gm/m²/day.

### 6.3.3. Coefficient of Friction

As used herein, the coefficient of friction (COF) relates to a measurement of friction between the compostable packaging material. Both the inside-to-inside and outside-to-outside COF of the present disclosure is measured using the ASTM D1894 method.

In certain embodiments, the static inside-to-inside COF of the compostable packaging material is from about 0.05 to about 1, from about 0.1 to about 0.75, or from about 0.2 to about 0.5. In particular embodiments, the kinetic inside-to-inside COF is from about 0.05 to about 0.75, from about 0.1, to about 0.5, or from about 0.2 to about 0.45.

In certain embodiments, the static outside-to-outside COF of the compostable packaging material is from about 0.05 to about 1, from about 0.1 to about 0.75, or from about 0.2 to about 0.5. In particular embodiments, the kinetic outside-to-outside COF is from about 0.05 to about 0.75, from about 0.1, to about 0.5, or from about 0.2 to about 0.45.

### 6.3.4. Lamination Bond Strength

As used herein, the lamination bond strength relates to a measurement of the force required to peel or remove a laminate from a substrate. The lamination bond strength of the present disclosure is measured based on the ASTM F-1306 method.

In certain embodiments, the lamination bond strength of the compostable packaging material is from about 5 N to about 15 N, or from about 7 N to about 13 N, or from about 9 N to about 11 N.

### 6.3.5. Tensile Strength and Elongation

As used herein, tensile strength and elongation percent are a measure of the amount of stress that can be applied before the material breaks. The tensile strength and elongation percent cut in both the machine direction and cross direction of the compostable packaging material is measured using a modified ASTM D-882 method.

In particular embodiments, the compostable packaging of the present disclosure has a machine direction tensile strength of from about 1,000 lb/in² to about 50,000 lb/in², from about 5,000 lb/in² to about 25,000 lb/in², or from about 8,000 lb/in² to about 10,000 lb/in², or alternatively, from about 10 N/mm² to about 500 N/mm², from about 25 N/mm² to about 250 N/mm², from about 40 N/mm² to about 100 N/mm², or from about 50 N/mm² to about 75 N/mm². In certain embodiments, the compostable packaging material has a machine direction elongation percent of from about 1% to about 150%, from about 10% to about 125%, from about 20% to about 40%, or from about 70% to about 100%.

In particular embodiments, the compostable packaging material of the present disclosure has a cross direction tensile strength of from about 1,000 lb/in² to about 50,000 lb/in², from about 4,000 lb/in² to about 20,000 lb/in², or from about 6,000 lb/in² to about 9,000 lb/in², or alternatively, from about 10 N/mm² to about 250 N/mm², from about 20 N/mm² to about 100 N/mm², or from about 30 N/mm² to about 60 N/mm². In certain embodiments, the compostable packaging material has a machine direction elongation percent of from about 1% to about 200%, from about 10% to about 175%, from about 20% to about 40%, or from about 100% to about 150%.

In addition, the compostable packaging material is home compostable or industrially compostable. In certain embodiments, the compostable packaging material is anaerobically digestible. In particular embodiments, the compostable packaging material is recyclable.

### 6.4. Consumer Products

The compostable packaging material of the present disclosure can be used to create packaging for any suitable consumer product. The consumer product can be a food product or a pet product. Non-limiting examples of a food product or a pet product include granola or protein bars, confections, dried fruit, bakery items (e.g., brownies, cookies), snack foods, coffee, tea, pet treats, pet kibble, and/or pet chew toys. The compostable packaging material can be used to form a blank or a box to form a package for a suitable consumer product.

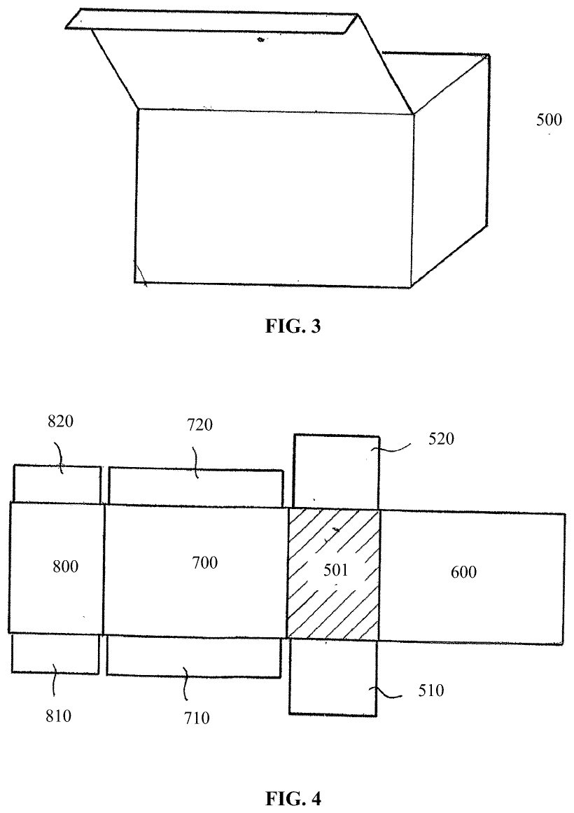

FIG. 3 provides a compostable package material provided as a blank. The blank can be manipulated to form a box, such as the box of FIG. 4. The blank has zones corresponding to the different parts of the box that can interact together to form a package, such as a box. The blank includes a base 501 that is flanked by two sides 600 and 700, the latter also being flanked by the upper part 800. The base 500 and the side 700 and the top 800 are provided with flaps 510 and 520, 710 and 720, and 810 and 820, respectively. These flaps can be adhesively bonded to one another to form the box, the flaps 510, 710, and 810, on the one hand, and 520, 720, and 820, on the other, thus forming the third and fourth sides 900 and 1000, respectively. The box comprising the compostable packaging comprises a housing configured to contain food therein, the housing including a compostable packaging material comprising a film layer, a bonding layer, and a substrate layer, wherein the compostable packaging material has an oxygen transmission rate of from about 0.1 cc/m²/day to about 15 cc/m²/day at 25° C. at 0% Relative Humidity, and of from about 0.1 cc/m²/day to about 30 cc/m²/day at 25° C. at 50% Relative Humidity, and/or a water vapor transmission rate of from about 0.05 gm/m²/day to about 7.5 gm/m²/day at 38° C. and 90% RH, and of from about 0.001 gm/m²/day to about 2.0 gm/m²/day at 25° C. and 50% RH.

### 7. EXAMPLES

The following examples are merely illustrative of the presently disclosed subject matter and they should not be considered as limiting the scope of the subject matter in any way.

The properties of various compostable packaging materials were measured, as described below. In Example 1, an unprinted compostable packaging material having a film layer of metalized PHA, and a substrate layer of cellulose acetate was studied. In Example 2, has a film compostable packaging that has text printing and logos thereon and comprising a film layer of metalized PHA and a substrate layer of cellulose acetate was studied. In Example 3, a compostable packaging material that has text printing and logos thereon and comprising a film layer of metalized PHA and a substrate layer of PHA was studied. In Example 4, an unprinted compostable packaging material having a film layer of metallized PHA, and a substrate layer of paper was studied.

### Example 1

In Example 1, multiple samples of an unprinted compostable packaging material having a film layer of metalized PHA, and a substrate layer of cellulose acetate were tested, as shown in Tables 1-9. The testing included a review of each sample's coefficient of friction, oxygen transmission rate, water vapor transition rate, penetration tests, and various tensile strengths.

The coefficient of friction is measured with a 200 g sled moving 6 inches per minute using the ASTM D1894 method. Both the inside-to-inside and outside-to-outside coefficient of friction was measured. The results are shown in Table 1.

TABLE 1
Coefficient of Friction Measurements.

| | Inside-Inside Coefficient of | | Outside-Outside Coefficient of | |
|---|---|---|---|---|
| | Friction | | Friction | |
| Sample | Static COF | Kinetic COF | Static COF | Kinetic COF |
| 1 | 0.34 | 0.28 | 0.44 | 0.34 |
| 2 | 0.48 | 0.35 | 0.36 | 0.24 |
| 3 | 0.41 | 0.37 | 0.43 | 0.24 |
| 4 | 0.32 | 0.4 | 0.45 | 0.26 |
| 5 | 0.45 | 0.35 | 0.39 | 0.25 |
| Avg | 0.40 | 0.35 | 0.41 | 0.27 |
| Std Dev | 0.07 | 0.04 | 0.04 | 0.04 |
| Min | 0.32 | 0.28 | 0.36 | 0.24 |
| Max | 0.48 | 0.40 | 0.45 | 0.34 |

As shown in the data above in Table 1, the average inside-inside static coefficient of friction is 0.40 with a standard deviation of 0.07 and the average inside-inside kinetic coefficient of friction is 0.35 with a standard deviation of 0.04.

As shown in the data above in Table 1, the average outside-outside static coefficient of friction is 0.41 with a standard deviation of 0.04 and the average outside-outside kinetic coefficient of friction is 0.27 with a standard deviation of 0.04.

The oxygen transmission rate was tested in a MOCON® oxygen transmission rate unit at 25° C. at 0% relative humidity (RH) and 25° C. at 50% RH until transmission equilibrium was achieved using a method based on the ASTM D-3895 method. The results are shown in Table 2.

TABLE 2
Oxygen Transmission Rates at 25° C. and 0% RH and 50% RH.

| | 25° C./0% RH | 25° C./50% RH |
|---|---|---|
| Sample | OTR (cc/m²/day) | OTR (cc/m²/day) |
| 1 | 0.42 | 0.24 |
| 2 | 0.36 | 0.6 |
| Average OTR | 0.39 | 0.42 |
| Film Thickness | 0.062 | 0.062 |
| (mm) | | |

As shown in the data above in Table 2, the average OTR at 25° C. at 0% RH was 0.39 cc/m²/day and at 25° C. at 50% RH was 0.42 cc/m²/day. These exceptionally good values, demonstrate that the compostable packaging provides suitable protection from oxidation for a number of consumer products.

The water vapor transmission rate was tested in a MOCON® water vapor transmission rate unit at 38° C. at 90% RH and 25° C. at 50% RH until transmission equilibrium was achieved using the ASTM F-1249 method. The results are shown in Table 3.

TABLE 3
Water Vapor Transmission Rates at 38° C.
and 90% RH and 25° C. and 50% RH.

| | 38° C./90% RH | 25° C./50% RH |
|---|---|---|
| Sample | WVTR (gm/m²/day) | WVTR (gm/m²/day) |
| 1 | 0.289 | 0.053 |
| 2 | 0.256 | 0.047 |
| Average WVTR | 0.2725 | 0.05 |
| Film Thickness | 0.062 | 0.062 |
| (mm) | | |

As shown in the data above the average WVTR at 38° C. at 90% RH was 0.27 gm/m²/day and at 25° C. at 50% RH was 0.05 gm/m²/day. These are exceptionally good values that provide significant protection for consumer products. Particularly, this is suitable for consumer products where moisture adsorption would alter the texture or create lumping in the product because of moisture ingress and prevents moisture from leaving products where they would dry out and become unsuitable for consumption.

The slow rate penetration resistance was measured at 1 in. per min. intervals, with the test set to stop at a 20% sudden loss of comprehensive load using the ASTM F-1306 method. The results are shown in Table 4.

TABLE 4
Slow Rate Penetration Test Results.

| | Penetration Force | Penetration Force |
|---|---|---|
| Sample | (lbf) | (N) |
| 1 | 4.31 | 19.17 |
| 2 | 4.52 | 20.10 |
| 3 | 4.60 | 20.46 |
| 4 | 4.69 | 20.86 |
| 5 | 4.90 | 21.80 |
| 6 | 4.56 | 20.28 |
| 7 | 4.93 | 21.93 |
| 8 | 4.78 | 21.26 |
| 9 | 4.42 | 19.66 |
| 10 | 5.00 | 22.24 |
| Avg | 4.67 | 20.78 |
| Std Dev | 0.23 | 1.02 |
| Min | 4.31 | 19.17 |
| Max | 5.00 | 22.24 |

As shown in the data above in Table 4, the average penetration force 4.67 lbf or 20.78 N. This demonstrates that the compostable packaging material can be used for a variety of consumer products, including products with sharp edges.

The tensile strength and elongation % were measured base using the ASTM D-882 method. The sample was cut into 1 in. side in both the machine and cross direction and tested using an Instron machine, with grips separating at a rate of 12 in. per min. The results are shown in Tables 5-8.

TABLE 5
Machine Direction Tensile Strength.

| | | | | | MD | MD |
|---|---|---|---|---|---|---|
| | | | Cross- | | Tensile | Tensile |
| | | | Sectional | Peak | Strength | Strength |
| | Width | Thickness | Area | Force | (lb./sq. | (N/sq. |
| Sample | (In.) | (in.) | (sq. in.) | (lbf.) | in.) | mm) |
| 1 | 1 | 0.002441 | 0.002441 | 21.24 | 8701.35 | 59.99 |
| 2 | 1 | 0.002441 | 0.002441 | 21.35 | 8746.42 | 60.30 |
| 3 | 1 | 0.002441 | 0.002441 | 21.41 | 8771.00 | 60.47 |
| 4 | 1 | 0.002441 | 0.002441 | 22.38 | 9168.37 | 63.21 |
| 5 | 1 | 0.002441 | 0.002441 | 22.86 | 9365.01 | 64.57 |
| Average | 1 | 0.002441 | 0.002441 | 21.848 | 8950.43 | 61.71 |
| Std | 0 | 0 | 0 | 0.73 | 298.01 | 2.05 |
| Min | 1 | 0.002441 | 0.002441 | 21.24 | 8701.35 | 59.99 |
| Max | 1 | 0.002441 | 0.002441 | 22.86 | 9365.01 | 64.57 |

TABLE 6
Machine Direction Tensile Elongation %.

| | Initial | Elongation | Total | MD |
|---|---|---|---|---|
| | Length | at Break | Length at | Elongation |
| Sample | (in.) | (in.) | Break (in.) | % |
| 1 | 4 | 1.37 | 5.37 | 34.25 |
| 2 | 4 | 1.37 | 5.37 | 34.25 |
| 3 | 4 | 1.4 | 5.4 | 35.00 |
| 4 | 4 | 1.54 | 5.54 | 38.50 |
| 5 | 4 | 1.55 | 5.55 | 38.75 |
| Average | 4 | 1.446 | 5.446 | 36.15 |
| Std | 0 | 0.09 | 0.09 | 2.28 |
| Min | 4 | 1.37 | 5.37 | 34.25 |
| Max | 4 | 1.55 | 5.55 | 38.75 |

TABLE 7
Cross Direction Tensile Strength.

| | | | | | MD | MD |
|---|---|---|---|---|---|---|
| | | | Cross- | | Tensile | Tensile |
| | | | Sectional | Peak | Strength | Strength |
| | Width | Thickness | Area | Force | (lb./sq. | (N/sq. |
| Sample | (In.) | (in.) | (sq. in.) | (lbf.) | in.) | mm) |
| 1 | 1 | 0.002441 | 0.002441 | 16.87 | 6911.10 | 47.65 |
| 2 | 1 | 0.002441 | 0.002441 | 16.53 | 6771.81 | 46.69 |
| 3 | 1 | 0.002441 | 0.002441 | 14.68 | 6013.93 | 41.46 |
| 4 | 1 | 0.002441 | 0.002441 | 16.87 | 6911.10 | 47.65 |
| 5 | 1 | 0.002441 | 0.002441 | 16.46 | 6743.14 | 46.49 |
| Average | 1 | 0.002441 | 0.002441 | 16.282 | 6670.22 | 45.99 |
| Std | 0 | 0 | 0 | 0.92 | 374.97 | 2.59 |
| Min | 1 | 0.002441 | 0.002441 | 14.68 | 6013.93 | 41.46 |
| Max | 1 | 0.002441 | 0.002441 | 16.87 | 6911.10 | 47.65 |

TABLE 8
Cross Direction Tensile Elongation %.

| | Initial | Elongation | Total | MD |
|---|---|---|---|---|
| | Length | at Break | Length at | Elongation |
| Sample | (in.) | (in.) | Break (in.) | % |
| 1 | 4 | 1.51 | 5.51 | 37.75 |
| 2 | 4 | 1.56 | 5.56 | 39.00 |
| 3 | 4 | 0.94 | 4.94 | 23.50 |
| 4 | 4 | 1.64 | 5.64 | 41.00 |
| 5 | 4 | 1.48 | 5.48 | 37.00 |
| Average | 4 | 1.426 | 5.426 | 35.65 |
| Std | 0 | 0.28 | 0.28 | 6.96 |
| Min | 4 | 0.94 | 4.94 | 23.5 |
| Max | 4 | 1.64 | 5.64 | 41 |

As shown in the data above in Tables 5-6, the average machine direction tensile strength was 8950.43 lb/in² or 61.71 N/mm² and the elongation percent was 36.15%. As shown in the data above in Tables 7-8, the average machine direction tensile strength was 6670.22 lb/in² or 45.99 N/mm² and the elongation percent was 37.75%.

In particular, the compostable packaging material with a film layer of metalized PHA and a substrate layer of cellulose acetate exhibited ideal oxygen transmission and water vapor transmission rates.

### Example 2

The properties of a compostable packaging material that has text printing and logos thereon and comprises a film layer of metalized PHA and a substrate layer of cellulose acetate were measured, as shown in Tables 9-16.

The oxygen transmission rate was tested in a MOCON® oxygen transmission rate unit at 25° C. at 0% relative humidity (RH) and 25° C. at 50% RH until transmission equilibrium was achieved using a method based on the ASTM D-3895 method. The results are shown in Table 9.

TABLE 9
Oxygen Transmission Rates at 25° C. and 0% RH and 50% RH.

| | 25° C. / 0% RH | 25° C. / 50% RH |
|---|---|---|
| Sample | OTR (cc/m²/day) | OTR (cc/m²/day) |
| 1 | 0.36 | 0.66 |
| 2 | 0.54 | 0.36 |
| Average OTR | 0.45 | 0.51 |
| Film Thickness | 0.066 | 0.066 |
| (mm) | | |

As shown in the data above in Table 9, the average OTR at 25° C. at 0% RH was 0.45 cc/m²/day and at 25° C. at 50% RH was 0.51 cc/m²/day. These exceptionally good values, demonstrate that the compostable packaging provides suitable protection from oxidation for a number of consumer products.

The water vapor transmission rate was tested in a MOCON® water vapor transmission rate unit at 38° C. at 90% RH and 25° C. at 50% RH until transmission equilibrium was achieved using the ASTM F-1249 method. The results are shown in Table 10.

TABLE 10
Water Vapor Transmission Rates at 38° C.
and 90% RH and 25° C. and 50% RH.

| | 38° C. / 90% RH | 25° C. / 50% RH |
|---|---|---|
| Sample | WVTR (gm/m²/day) | WVTR (gm/m²/day) |
| 1 | 0.199 | 0.022 |
| 2 | 0.246 | 0.033 |
| Average WVTR | 0.2225 | 0.0275 |
| Film Thickness | 0.066 | 0.066 |
| (mm) | | |

As shown in the data above in Table 10, the average WVTR at 38° C. at 90% RH was 0.22 gm/m²/day and at 25° C. at 50% RH was 0.03 gm/m²/day. These are exceptionally good values that provide significant protection for consumer products. Particularly, this is suitable for consumer products where moisture adsorption would alter the texture or create lumping in the product because of moisture ingress and prevents moisture from leaving products where they would dry out and become unsuitable for consumption.

The slow rate penetration resistance was measured at 1 in. per min. intervals, with the test set to stop at a 20% sudden loss of comprehensive load using the ASTM F-1306 method. The results are shown in Table 11.

TABLE 11
Slow Rate Penetration Test Results.

| | Penetration | Penetration |
|---|---|---|
| Sample | Force (lbf) | Force (N) |
| 1 | 4.97 | 22.11 |
| 2 | 5.35 | 23.80 |
| 3 | 5.44 | 24.20 |
| 4 | 5.29 | 23.53 |
| 5 | 5.39 | 23.97 |
| 6 | 5.33 | 23.71 |
| 7 | 5.23 | 23.26 |
| 8 | 5.13 | 22.82 |
| 9 | 5.16 | 22.95 |
| 10 | 5.14 | 22.86 |
| Avg | 5.24 | 23.32 |
| Std Dev | 0.14 | 0.64 |
| Min | 4.97 | 22.11 |
| Max | 5.44 | 24.20 |

As shown in the data above in Table 11, the average penetration force 5.21 lbf or 23.32 N. This demonstrates that the compostable packaging material can be used for a variety of consumer products, including products with sharp edges.

The tensile strength and elongation % were measured base using the ASTM D-882 method. The sample was cut into 1 in. side in both the machine and cross direction and tested using an Instron machine, with grips separating at a rate of 12 in. per min. The results are shown in Tables 12-15.

TABLE 12
Machine Direction Tensile Strength.

| | | | | | MD | MD |
|---|---|---|---|---|---|---|
| | | | Cross- | | Tensile | Tensile |
| | | | Sectional | Peak | Strength | Strength |
| | Width | Thickness | Area | Force | (lb./sq. | (N/sq. |
| Sample | (In.) | (in.) | (sq. in.) | (lbf.) | in.) | mm) |
| 1 | 1 | 0.002598 | 0.002598 | 21.93 | 8441.11 | 58.20 |
| 2 | 1 | 0.002598 | 0.002598 | 22.35 | 8602.77 | 59.31 |
| 3 | 1 | 0.002598 | 0.002598 | 22.41 | 8625.87 | 59.47 |
| 4 | 1 | 0.002598 | 0.002598 | 22.18 | 8537.34 | 58.86 |
| 5 | 1 | 0.002598 | 0.002598 | 22.31 | 8587.37 | 59.21 |
| Average | 1 | 0.002598 | 0.002598 | 22.236 | 8558.89 | 59.01 |
| Std | 0 | 0 | 0 | 0.19 | 73.42 | 0.51 |
| Min | 1 | 0.002598 | 0.002598 | 21.93 | 8441.11 | 58.20 |
| Max | 1 | 0.002598 | 0.002598 | 22.41 | 8625.87 | 59.47 |

TABLE 13
Machine Direction Tensile Elongation %.

| | Initial | Elongation | Total | MD |
|---|---|---|---|---|
| | Length | at Break | Length at | Elongation |
| Sample | (in.) | (in.) | Break (in.) | % |
| 1 | 4 | 1.4 | 5.4 | 35.00 |
| 2 | 4 | 1.4 | 5.4 | 35.00 |
| 3 | 4 | 1.46 | 5.46 | 36.50 |
| 4 | 4 | 1.45 | 5.45 | 36.25 |
| 5 | 4 | 1.49 | 5.49 | 37.25 |
| Average | 4 | 1.44 | 5.44 | 36 |
| Std | 0 | 0.04 | 0.04 | 0.98 |
| Min | 4 | 1.4 | 5.4 | 35 |
| Max | 4 | 1.49 | 5.49 | 37.25 |

TABLE 14
Cross Direction Tensile Strength.

| | | | | | MD | MD |
|---|---|---|---|---|---|---|
| | | | Cross- | | Tensile | Tensile |
| | | | Sectional | Peak | Strength | Strength |
| | Width | Thickness | Area | Force | (lb./sq. | (N/sq. |
| Sample | (In.) | (in.) | (sq. in.) | (lbf.) | in.) | mm) |
| 1 | 1 | 0.002598 | 0.002598 | 17.38 | 6689.76 | 46.12 |
| 2 | 1 | 0.002598 | 0.002598 | 16.09 | 6193.23 | 42.70 |
| 3 | 1 | 0.002598 | 0.002598 | 16.79 | 6462.66 | 44.56 |
| 4 | 1 | 0.002598 | 0.002598 | 15.56 | 5989.22 | 41.29 |
| 5 | 1 | 0.002598 | 0.002598 | 16.73 | 6439.57 | 44.40 |
| Average | 1 | 0.002598 | 0.002598 | 16.51 | 6354.89 | 43.82 |
| Std | 0 | 0 | 0 | 0.70 | 269.62 | 1.86 |
| Min | 1 | 0.002598 | 0.002598 | 15.56 | 5989.22 | 41.29 |
| Max | 1 | 0.002598 | 0.002598 | 17.38 | 6689.76 | 46.12 |

TABLE 15
Cross Direction Tensile Elongation %.

| | | | Total | |
|---|---|---|---|---|
| | Initial | Elongation | Length | MD |
| | Length | at Break | at Break | Elongation |
| Sample | (in.) | (in.) | (in.) | % |
| 1 | 4 | 1.68 | 5.68 | 42.00 |
| 2 | 4 | 1.37 | 5.37 | 34.25 |
| 3 | 4 | 1.54 | 5.54 | 38.50 |
| 4 | 4 | 1.15 | 5.15 | 28.75 |
| 5 | 4 | 1.53 | 5.53 | 38.25 |
| Average | 4 | 1.454 | 5.454 | 36.35 |
| Std | 0 | 0.20 | 0.20 | 5.06 |
| Min | 4 | 1.15 | 5.15 | 28.75 |
| Max | 4 | 1.68 | 5.68 | 42 |

As shown in the data above in Tables 12 and 13, the average machine direction tensile strength was 8558.98 lb/in² or 59.01 N/mm² and the elongation percent was 36%. As shown in the data above in Tables 7-8, the average machine direction tensile strength was 6354.89 lb/in² or 43.82 N/mm² and the elongation percent was 36.35%.

As shown in comparing the testing values of the unprinted compostable packaging material of Example 1 with the compostable packaging material that has text printing and logos thereon and comprises a film layer of metalized PHA and a substrate layer of cellulose acetate of Example 2, the printing addition to the packaging had minimal effect on the tested properties above.

### Example 3

The properties of a compostable packaging material that has text printing and logos and comprises a film layer of metalized PHA and a substrate layer of PHA was measured, as shown in Tables 16-23.

The oxygen transmission rate was tested in a MOCON® oxygen transmission rate unit at 25° C. at 0% relative humidity (RH) and 25° C. at 50% RH until transmission equilibrium was achieved using a method based on the ASTM D-3895 method. The results are shown in Table 16.

TABLE 16
Oxygen Transmission Rates at 25° C. and 0% RH and 50% RH.

| | 25° C. / 0% RH | 25° C. / 50% RH |
|---|---|---|
| Sample | OTR (cc/m²/day) | OTR (cc/m²/day) |
| 1 | 0.54 | 0.36 |
| 2 | 0.78 | 0.3 |
| Average OTR | 0.66 | 0.33 |
| Film Thickness | 0.074 | 0.074 |
| (mm) | | |

As shown in the data above in Table 16, the average OTR at 25° C. at 0% RH was 0.66 cc/m²/day and at 25° C. at 50% RH was 0.39 cc/m²/day. These exceptionally good values, demonstrate that the compostable packaging provides suitable protection from oxidation for a number of consumer products.

The water vapor transmission rate was tested in a MOCON® water vapor transmission rate unit at 38° C. at 90% RH and 25° C. at 50% RH until transmission equilibrium was achieved using the ASTM F-1249 method. The results are shown in Table 17.

TABLE 17
Water Vapor Transmission Rates at 38° C.
and 90% RH and 25° C. and 50% RH.

| | 38° C. / 90% RH | 25° C. / 50% RH |
|---|---|---|
| Sample | WVTR (gm/m²/day) | WVTR (gm/m²/day) |
| 1 | 0.179 | 0.041 |
| 2 | 0.233 | 0.048 |
| Average WVTR | 0.206 | 0.0445 |
| Film Thickness | 0.074 | 0.074 |
| (mm) | | |

As shown in the data above in Table 17, the average WVTR at 38° C. at 90% RH was 0.21 gm/m²/day and at 25° C. at 50% RH was 0.04 gm/m²/day. These are exceptionally good values that provide significant protection for consumer products. Particularly, this is suitable for consumer products where moisture adsorption would alter the texture or create lumping in the product because of moisture ingress and prevents moisture from leaving products where they would dry out and become unsuitable for consumption.

The slow rate penetration resistance was measured at 1 in. per min. intervals, with the test set to stop at a 20% sudden loss of comprehensive load using the ASTM F-1306 method. The results are shown in Table 18.

TABLE 18
Slow Rate Penetration Test Results.

| | Penetration | Penetration |
|---|---|---|
| Sample | Force (lbf) | Force (N) |
| 1 | 12.21 | 54.31 |
| 2 | 11.52 | 51.24 |
| 3 | 11.80 | 52.49 |
| 4 | 12.92 | 57.47 |
| 5 | 11.44 | 50.89 |
| 6 | 12.16 | 54.09 |
| 7 | 13.21 | 58.76 |
| 8 | 11.72 | 52.13 |
| 9 | 12.58 | 55.96 |
| 10 | 12.81 | 56.98 |
| Avg | 12.24 | 54.43 |
| Std Dev | 0.62 | 2.76 |
| Min | 11.44 | 50.89 |
| Max | 13.21 | 58.76 |

As shown in the data above in Table 18, the average penetration force 12.24 lbf or 54.43 N. This demonstrates that the compostable packaging material can be used for a variety of consumer products, including products with sharp edges.

The tensile strength and elongation % were measured base using the ASTM D-882 method. The sample was cut into 1 in. side in both the machine and cross direction and tested using an Instron machine, with grips separating at a rate of 12 in. per min. The results are shown in Tables 19-22.

TABLE 19
Machine Direction Tensile Strength.

| | | | | | MD | MD |
|---|---|---|---|---|---|---|
| | | | Cross- | | Tensile | Tensile |
| | | | Sectional | Peak | Strength | Strength |
| | Width | Thickness | Area | Force | (lb./sq. | (N/sq. |
| Sample | (In.) | (in.) | (sq. in.) | (lbf.) | in.) | mm) |
| 1 | 1 | 0.002598 | 0.002598 | 26.3 | 10123.17 | 69.80 |
| 2 | 1 | 0.002598 | 0.002598 | 25.7 | 9892.22 | 68.20 |
| 3 | 1 | 0.002598 | 0.002598 | 23.97 | 9226.33 | 63.61 |
| 4 | 1 | 0.002598 | 0.002598 | 22.26 | 8568.13 | 59.08 |
| 5 | 1 | 0.002598 | 0.002598 | 24.92 | 9591.99 | 66.13 |
| Average | 1 | 0.002598 | 0.002598 | 24.63 | 9480.37 | 65.36 |
| Std | 0 | 0 | 0 | 1.59 | 610.74 | 4.21 |
| Min | 1 | 0.002598 | 0.002598 | 22.26 | 8568.13 | 59.08 |
| Max | 1 | 0.002598 | 0.002598 | 26.3 | 10123.17 | 69.80 |

TABLE 20
Machine Direction Tensile Elongation %.

| | | | Total | |
|---|---|---|---|---|
| | Initial | Elongation | Length | MD |
| | Length | at Break | at Break | Elongation |
| Sample | (in.) | (in.) | (in.) | % |
| 1 | 4 | 4.11 | 8.11 | 102.75 |
| 2 | 4 | 3.81 | 7.81 | 95.25 |
| 3 | 4 | 3.36 | 7.36 | 84.00 |
| 4 | 4 | 3.22 | 7.22 | 80.50 |
| 5 | 4 | 4.02 | 8.02 | 100.50 |
| Average | 4 | 3.704 | 7.704 | 92.6 |
| Std | 0 | 0.40 | 0.40 | 9.91 |
| Min | 4 | 3.22 | 7.22 | 80.5 |
| Max | 4 | 4.11 | 8.11 | 102.75 |

TABLE 21
Cross Direction Tensile Strength.

| | | | | | CD | CD |
|---|---|---|---|---|---|---|
| | | | Cross- | | Tensile | Tensile |
| | | | Sectional | Peak | Strength | Strength |
| | Width | Thickness | Area | Force | (lb./sq. | (N/sq. |
| Sample | (In.) | (in.) | (sq. in.) | (lbf.) | in.) | mm) |
| 1 | 1 | 0.002598 | 0.002598 | 22.13 | 8518.09 | 58.73 |
| 2 | 1 | 0.002598 | 0.002598 | 21.54 | 8290.99 | 57.16 |
| 3 | 1 | 0.002598 | 0.002598 | 20.01 | 7702.08 | 53.10 |
| 4 | 1 | 0.002598 | 0.002598 | 19.44 | 7482.68 | 51.59 |
| 5 | 1 | 0.002598 | 0.002598 | 22.25 | 8564.28 | 59.05 |
| Average | 1 | 0.002598 | 0.002598 | 21.074 | 8111.62 | 55.93 |
| Std | 0 | 0 | 0 | 1.28 | 491.32 | 3.39 |
| Min | 1 | 0.002598 | 0.002598 | 19.44 | 7482.68 | 51.59 |
| Max | 1 | 0.002598 | 0.002598 | 22.25 | 8564.28 | 59.05 |

TABLE 22
Cross Direction Tensile Elongation %.

| | | | Total | |
|---|---|---|---|---|
| | Initial | Elongation | Length | MD |
| | Length | at Break | at Break | Elongation |
| Sample | (in.) | (in.) | (in.) | % |
| 1 | 4 | 5.21 | 9.21 | 130.25 |
| 2 | 4 | 4.83 | 8.83 | 120.75 |
| 3 | 4 | 4.86 | 8.86 | 121.50 |
| 4 | 4 | 4.46 | 8.46 | 111.50 |
| 5 | 4 | 4.8 | 8.8 | 120.00 |
| Average | 4 | 4.832 | 8.832 | 120.8 |
| Std | 0 | 0.27 | 0.27 | 6.65 |
| Min | 4 | 4.46 | 8.46 | 111.5 |
| Max | 4 | 5.21 | 9.21 | 130.25 |

As shown in the data above in Tables 19 and 20, the average machine direction tensile strength was 9480.37 lb/in² or 65.36 N/mm² and the elongation percent was 92.6%. As shown in the data above in Tables 21 and 22, the average machine direction tensile strength was 8111.62 lb/in² or 55.93 N/mm² and the elongation percent was 120.8%.

In particular, the compostable packaging material that has text printing and logos thereon and comprises a film layer of metalized PHA and a substrate layer of PHA performed comparably to the compostable packaging material with the cellulose acetate substrate layer.

### Example 4

In Example 4, multiple samples of an unprinted compostable packaging material having a film layer of metalized PHA, and a substrate layer of paper were prepared by laminating metalized PHA to Ahlstrom commercial paper (UC300 or UC400). Laminations were performed using Sun Chemical SunLam™ adhesive SFC100/HAC306 at a coat weight of either 1.5 grams per square meter (gsm) or 2.4 gsm as shown in Table 23. Various properties of each sample were tested as shown in Tables 24-27. The testing included a review of each sample's oxygen transmission rate, water vapor transition rate, bond strength, and penetration tests.

TABLE 23
Paper-Based Compostable Packaging Material Samples.

| | Paper | Adhesive Coat |
|---|---|---|
| Sample | Substrate | Weight (gsm) |
| 1 | UC300 | 1.5 |
| 2 | UC300 | 2.4 |
| 3 | UC400 | 1.5 |
| 4 | UC400 | 2.4 |

The oxygen transmission rate was tested in a MOCON® oxygen transmission rate unit at 25° C. at 50% relative humidity (RH) until transmission equilibrium was achieved using a method based on the ASTM D-3895 method. The results are shown in Table 24.

TABLE 24
Oxygen Transmission Rates at 25° C. at 50% RH.

| | OTR (cc/m²/day) at |
|---|---|
| Sample | 25° C. / 50% RH |
| 1 | 0.2-0.6 |
| 2 | 0.54-0.66 |
| 3 | 0.24-0.84 |
| 4 | 0.96-1.62 |

As shown in the data above in Table 24, the OTR at 25° C. and 50% RH of the samples varied between 0.2-0.6 cc/m²/day to 0.96-1.62 cc/m²/day. These exceptionally good values demonstrate that the compostable packaging provides suitable protection from oxidation for a number of consumer products.

The water vapor transmission rate was tested in a MOCON® water vapor transmission rate unit at 35° C. at 85% RH until transmission equilibrium was achieved using the ASTM F-1249 method. The results are shown in Table 25.

TABLE 25
Water Vapor Transmission Rates at 35° C. at 85% RH.

| | WVTR (gm/m² /day) at |
|---|---|
| Sample | 35° C. / 85% RH |
| 1 | 0.07-0.1 |
| 2 | 0.538-1.103 |
| 3 | 0.09-0.091 |
| 4 | 0.245-0.531 |

As shown above in Table 25, the WVTR at 35° C. at 85% RH of the samples varied between 0.07-0.1 g/m²/day and to 0.538-1.103 gm/m²/day. These are exceptionally good values that provide significant protection for consumer products. Particularly, this is suitable for consumer products where moisture adsorption would alter the texture or create lumping in the product because of moisture ingress and prevents moisture from leaving products where they would dry out and become unsuitable for consumption.

The lamination bond strength was tested using the ASTM F904 method. The results are shown in Table 26.

TABLE 26
Bond Strength.

| Sample | Bond Strength (N) |
|---|---|
| 1 | 10.1 ± 2 |
| 2 | 10.8 ± 2 |
| 3 | 9.09 ± 2 |
| 4 | 9.03 ± 2 |

As shown above in Table 26, the lamination bond strength of the samples varied between 9.03±2 N and 10.8±2 N. This demonstrates that the lamination of the compostable packaging maintains structural integrity during use as a packaging material for consumer products.

The slow rate penetration resistance was measured at 1 in. per min. intervals, with the test set to stop at a 20% sudden loss of comprehensive load using the ASTM F-1306 method. The results are shown in Table 27.

TABLE 27
Slow Rate Penetration Test Results.

| | Penetration |
|---|---|
| Sample | Force (N) |
| 1 | 11.2 |
| 2 | — |
| 3 | 11.8 |
| 4 | — |

As shown in the data above in Table 27, Samples 1 and 3 exhibited penetration forces of 11.2 N and 11.8 N, respectively. This demonstrates that the compostable packaging material can be used for a variety of consumer products, including products with sharp edges.

In addition to the various embodiments depicted and claimed, the disclosed subject matter is also directed to other embodiments having other combinations of the features disclosed and claimed herein. As such, the particular features presented herein can be combined with each other in other manners within the scope of the disclosed subject matter such that the disclosed subject matter includes any suitable combination of the features disclosed herein. The foregoing description of specific embodiments of the disclosed subject matter has been presented for purposes of illustration and description. It is not intended to be exhaustive or to limit the disclosed subject matter to those embodiments disclosed.

It will be apparent to those skilled in the art that various modifications and variations can be made in the systems and methods of the disclosed subject matter without departing from the spirit or scope of the disclosed subject matter. Thus, it is intended that the disclosed subject matter include modifications and variations that are within the scope of the appended claims and their equivalents.

Various patents and patent applications are cited herein, the contents of which are hereby incorporated by reference herein in their entireties.

What is claimed is:

1. A compostable packaging material comprising:
a film layer comprising polyhydroxyalkanoate (PHA);
a bonding layer; and
a substrate layer;
wherein the compostable packaging material has a water vapor transmission rate of from about 0.05 gm/m²/day to about 7.5 gm/m²/day at 38° C. and 90% Relative Humidity, and from about 0.001 gm/m²/day to about 2.0 gm/m²/day at 25° C. and 50% Relative Humidity, wherein the compostable packaging material is configured to be assembled into a package to contain a food product or pet product and is configured to be compostable.

2. The compostable packaging material of claim 1, wherein the compostable packaging material has an oxygen transmission rate of from about 0.1 cc/m²/day to about 15 cc/m²/day at 25° C. at 0% Relative Humidity, and of from about 0.1 cc/m²/day to about 30 cc/m²/day at 25° C. at 50% Relative Humidity.

3. The compostable packaging material of claim 1, wherein the film layer comprises a PHA sublayer, a primer sublayer, and a barrier sublayer.

4. The compostable packaging material of claim 3, wherein the barrier sublayer comprises aluminum, aluminum oxide, silicon oxide, graphene, chitin and/or chitosan, chitin and/or chitosan mixed with inorganic clays, or montmorillonite blends.

5. The compostable packaging material of claim 1, wherein the film layer has a thickness of less than about 50 μm.

6. The compostable packaging material of claim 1, wherein the substrate layer comprises cellulose acetate, PHA, paper, a pulp, or a board material.

7. The compostable packaging material of claim 6, wherein the substrate layer is PHA having a thickness of from about 5 μm to about 90 μm.

8. The compostable packaging material of claim 6, wherein the substrate layer is paper having a basis weight of from about 18 gsm to about 600 gsm.

9. The compostable packaging material of claim 6, wherein the substrate layer is a board or pulp having a basis weight of from about 10 gsm to about 1000 gsm.

10. The compostable packaging material of claim 1, wherein the bonding layer is an adhesive layer.

11. The compostable packaging material of claim 10, wherein the adhesive layer has a basis weight of from about 0.1 gsm to about 10 gsm.

12. A compostable package, comprising:
a housing configured to contain food therein, the housing including a compostable packaging material comprising:
a film layer comprising polyhydroxyalkanoate, a bonding layer, and a substrate layer,
wherein the compostable packaging material has a water vapor transmission rate of from about 0.05 gm/m²/day to about 7.5 gm/m²/day at 38° C. and 90% Relative Humidity, and from about 0.001 gm/m²/day to about 2.0 gm/m²/day at 25° C. and 50% Relative Humidity.

13. The compostable package of claim 12, wherein the compostable packaging material has an oxygen transmission rate of from about 0.1 cc/m²/day to about 15 cc/m²/day at 25° C. at 0% Relative Humidity, and of from about 0.1 cc/m²/day to about 30 cc/m²/day at 25° C. at 50% Relative Humidity.

14. The compostable package of claim 12, wherein the film layer comprises a PHA sublayer, a primer sublayer, and a barrier sublayer.

15. The compostable packaging material of claim 12, wherein the substrate layer comprises cellulose acetate, PHA, paper, a pulp, or a board material.

16. The compostable package of claim 15, wherein the bonding layer is an adhesive layer with a basis weight of from about 0.1 gsm to about 10 gsm.

17. The compostable package of claim 12, further comprising a food product or a pet product therein.

18. A method of making a compostable package material, comprising:
coating polyhydroxyalkanoate (PHA) with a primer sublayer and a barrier sublayer to form a film layer,
processing the coated film with a bonding layer to create an intermediate product; and
coupling the intermediate product with a substrate layer to create a compostable packaging material,
wherein the substrate layer includes at least one of cellulose acetate, PHA, paper, a pulp, or a board, and
wherein the compostable packaging material has a water vapor transmission rate of from about 0.05 gm/m²/day to about 7.5 gm/m²/day at 38° C. and 90% Relative Humidity, and from about 0.001 gm/m²/day to about 2.0 gm/m²/day at 25° C. and 50% Relative Humidity.

19. The method of claim 18, further comprising forming the compostable packaging material into a package.

20. The method of claim 18, wherein the compostable packaging material has an oxygen transmission rate of from about 0.1 cc/m²/day to about 15 cc/m²/day at 25° C. at 0% Relative Humidity, and of from about 0.1 cc/m²/day to about 30 cc/m²/day at 25° C. at 50% Relative Humidity.
